(19) United States
(12) Patent Application Publication
(10) Pub. No.: US 2013/0254322 A1
(43) Pub. Date: Sep. 26, 2013

(54) NETWORK LINKED DATA CARRIERS

(71) Applicants: Barry J. Lipsky, Princeton Junction, NJ (US); Pang Lee, Tseung Kwan O (HK); Wong Ho Por, Ma On Shan (HK); Liu Sin Kwan Cindy, Shatin (HK)

(72) Inventors: Barry J. Lipsky, Princeton Junction, NJ (US); Pang Lee, Tseung Kwan O (HK); Wong Ho Por, Ma On Shan (HK); Liu Sin Kwan Cindy, Shatin (HK)

(73) Assignee: FRANKLIN ELECTRONIC PUBLISHERS, INCORPORATED, Burlington, NJ (US)

(21) Appl. No.: 13/425,063

(22) Filed: Mar. 20, 2012

(51) Int. Cl. G06F 15/167

(52) U.S. Cl. 709/213

(57) ABSTRACT

A data carrier carries at least one identifier capable of being read by an electronic aid and is used by associating content in the form of a digital audio recording with an identifier coded on a data carrier to be read out loud by an aid. Such content is based on the words entered on the pages of a printed book. Such data carriers may be generated directly by the use of circuitry for recording contained in said electronic aid or generated indirectly by recording said content and storing the resultant digital files in memory on a computer, and thereafter uploading said files into memory of a server that may be accessed by the intended user of an electronic aid through a network by downloading said files into a handheld electronic aid for use with correlated data carriers on the pages of such book.

### FIELD OF THE INVENTION

The present invention relates in general to data carriers for use with a handheld electronic aid adapted for reading aloud information stored in the electronic aid correlated to an identifier printed on the data carrier and an improvement in the use of such an electronic reading aloud system based in part on a method for sharing such information for use by geographically disparate users by linking data carriers through the medium of a network of computers, such as the World Wide Web.

### BACKGROUND OF THE INVENTION

Data carriers, adapted to be read by a handheld electronic aid capable of reading an identifier printed on the data carrier, are found in commerce such as those used in connection with the electronic aid sold under the mark AnyBook™ by Franklin Electronic Publishers, Inc. Data carriers can typically take the form of labels or sheets of paper. Identifiers can take the form of one or more patterns of dots on the data carrier that may be too small to be visually perceived by a human reader, but can be read by an electronic aid adapted for that purpose. In other circumstances, the identifiers can be printed with various inks in the visual spectrum or the ultra violet spectrum. Identifiers can be printed in a grid pattern with an x and y axis. Alternatively, identifiers can be printed in a radial pattern. Identifiers can also be printed in various other patterns and techniques commonly used in the art. Often, a plurality of identifiers is found on a single data carrier, thereby permitting the electronic aid to read the identifier at any number of places on the surface of a data carrier. In many instances, the electronic aid uses reference points on the identifier to read the identifier in any rotational orientation through the use of a software algorithm.

Data carriers capable of being read by the use of a handheld electronic aid can be used for various purposes. One common application generally involves the use of a data carrier that is affixed to an item, such as a container of medicine or the page of a book. The information to be read aloud may be, in the case of the container of medicine, an audio clip corresponding to a the name of a medication, the dosage of medication to be taken, or instructions for taking such medication for the benefit of the aged or sight impaired. In such case, the audio clip is stored in memory in the electronic aid and correlated to the identifiers coded on such data carriers. With respect to use of data carriers on the pages of a printed book, the information to be read aloud is in most cases the words entered on the page to which the data carrier is affixed. With regard to the use of data carriers on pages of books or other educational materials, see applicant's pending U.S. application Ser. No. 13/189,868. The words are recorded into memory of the electronic aid in correlation with the identifiers coded on the data carrier on the page in question and read by the electronic aid. The audio recording can then be replayed by reading the data carrier with the electronic aid for the benefit of a young child who is going to bed or an older child who is learning to read. The audio recording is associated with the particular identifier and stored in the electronic aid, along with a reference to identifier.

For example, U.S. patent application Ser. No. 12/989,426 discloses the use of labels with identifiers that can be affixed, for example, to food items in order to assist visually impaired individuals with article identification. With respect to the instant invention, data carriers can be used to read out information aloud that is stored in a handheld electronic aid such as the AnyBook™ Reader designed and sold by Franklin Electronic Publishers, Inc. that is mainly intended to facilitate a parent's desire to have his or her familiar voice be used to read aloud the words printed on the pages of a children's book for his or her child's enjoyment.

Given the geographic diaspora of many formerly nuclear families in today's world, the problem to be solved by the instant invention is “How can Grandmom, who lives back East, read a bedtime story to her three year old grandson, who lives with his mother on the West Coast?” Or “How can dad, who is a Navy Seal stationed in Asia Minor, read a favorite book to his daughter back home?” By extension, one can appreciate that the publisher of children's books may want to make available page by page audio recordings of each of its children's books and, in accordance with the instant invention, may do so by uploading digital audio files just one time with the result that those files can be downloaded by many users of handheld electronic aids, such as the AnyBook™ Reader. Additionally, a teacher may upload recordings one time and reach a class of thirty students, each of whom has access to texts on which data carriers have been affixed to be read out as study help.

### SUMMARY OF THE INVENTION

According to the present invention, the foregoing and other objects and advantages are obtained by utilizing a data carrier for use with an electronic aid adapted for reading an identifier printed on the data carrier and electronically connectable to a personal computer, tablet computer, or smartphone, in accordance with the improvements set forth herein by which data carriers may be linked over a network of computers.

The data associated with the identifier, the recorded sound information, and the link between the identifier and the recorded and stored sound information can be stored, for example, in memory within the handheld electronic aid or, in accordance with the preferred embodiment of the instant invention, may be recorded directly on and stored in a personal computer, tablet computer, or smartphone, for download into a handheld electronic aid. Additionally, information recorded in the device may be uploaded into the memory of the local computer. Such identifier, such sound information, and such link may be stored, for example, in the memory within a computer system by means for data communication to and from at least one electronic aid by a USB connection, for example, in the preferred embodiment or wirelessly, such as by a Bluetooth™ connection. Such information may then be shared, by the process of linking the local computer to a server for access by geographically disparate users over the internet.

The instant invention solves the problem of the geographically disparate, yet loving, grandmother by way of a tripartite desktop under the control of an application software program running on a local computer that provides for access to a server on which content, in the form of digital audio files, can be uploaded by the grandmother for subsequent downloading by the parent of her three year old grandson in California, independent of the actual identifiers that will be used on the data carriers to be affixed to the pages of the book by the person downloading such audio files. Such desktop in the preferred embodiment is comprised of three sections that track and allow access to content of this nature that is stored (i) on the local computer of a user, (ii) on said server, or (iii) in a handheld electronic aid.

Other details, objects, and advantages of the present invention will become apparent as the following description of the presently preferred embodiment and presently preferred method of practicing the invention proceeds.

### BRIEF DESCRIPTION OF THE DRAWINGS

The invention will become more readily apparent from the following description of the preferred embodiment thereof shown, by way of example only, in the accompanying drawings wherein:

FIG. 1 is a screenshot of the desktop under the control of a application software program running on a local computer according to one embodiment of the invention;

FIG. 2 is a perspective view of a handheld electronic aid for reading aloud information correlated to identifiers printed on data carriers in accordance with the present invention;

FIG. 3 shows a printed book to which data carriers have been affixed;

FIG. 4 depicts certain icons providing certain functions to be performed on a server under the control of a user of the desktop of FIG. 1.

FIG. 5 depicts certain icons providing certain functions to be performed on a local computer under the control or by a user of the desktop of FIG. 1.

FIG. 6. depicts certain icons providing certain functions to be performed on a handheld electronic device under the control of a user of the desktop of FIG. 1.

FIG. 7. is a block diagram of the system of the present invention.

### DETAILED DESCRIPTION OF THE INVENTION

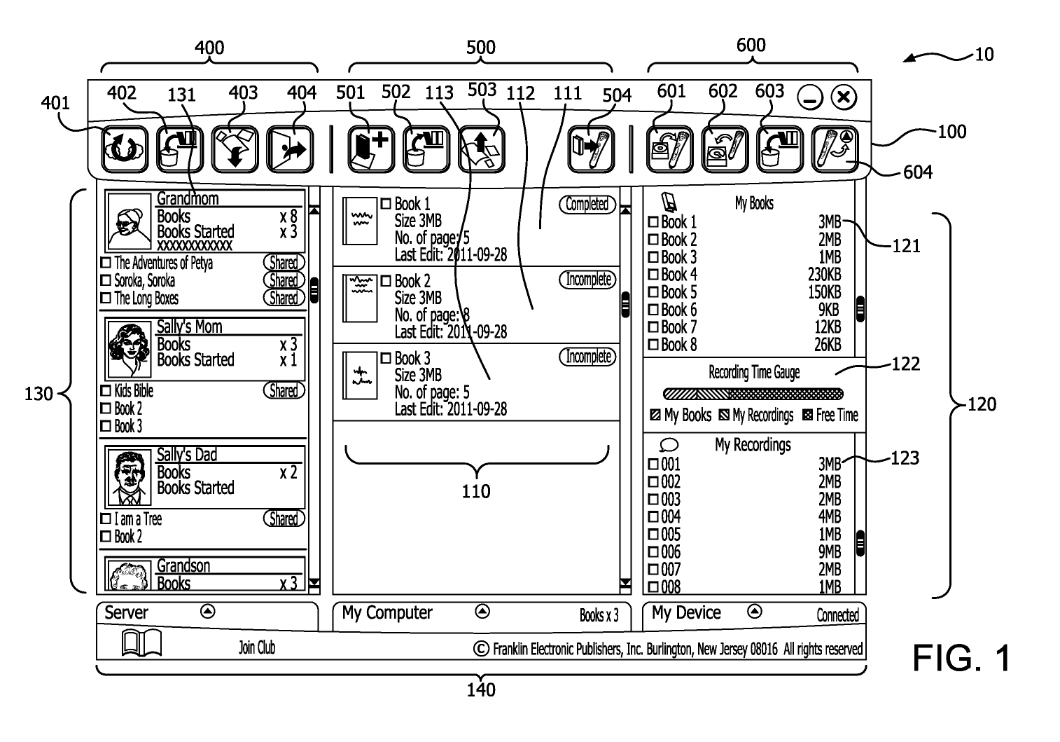

Referring to the drawings wherein like or similar references indicate like or similar elements throughout the several views, there is shown in FIG. 1 a screenshot of the desktop controlled under the operation of an application software program running on a personal computer, or tablet computer, or smartphone that can be accessed by the user of a handheld electronic aid of the instant invention.

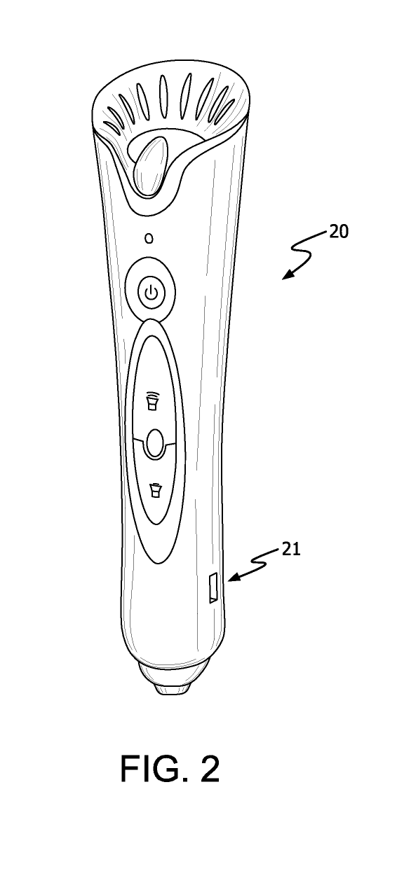

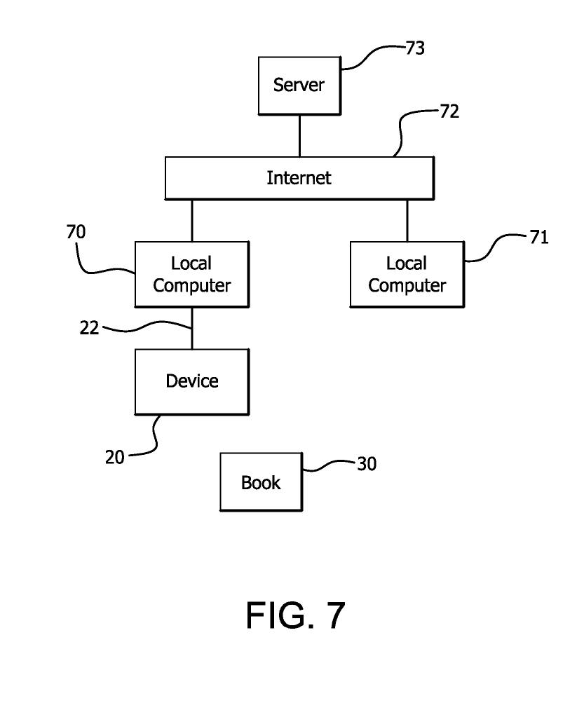

The preferred embodiment of the invention as shown in FIG. 1 is centered on a control panel for the linking of data carriers on a network, such as the Internet, which is depicted as a desktop 10 that is provided on the screen of a personal computer, tablet computer, or smartphone used by one or both of the following: (i) a user and possessor of a handheld electronic device as shown in FIG. 2; or (ii) a content provider of digital audio files (as may be referred to herein as “content”) that are intended to be stored in one or more of such handheld electronic devices to be read out aloud in correlation with identifiers that have been printed on data carriers affixed to pages of a print book. Such desktop is under the control of an application software computer program running on said personal computer, tablet computer, or smartphone (hereinafter any one of the three being referred to as “a local computer” such as block 70 as labeled in FIG. 7) and is tripartite in nature, having one section 110 tracking and identifying content that is stored in the memory of said local computer; having another section 120 tracking and identifying content that may be stored in the memory of said handheld electronic device; and a third section 130 tracking and identifying content that may be stored in the memory of a configured server that is connected to said local computer, in the preferred embodiment, over the Internet in a manner known in the art, such as via a browser program, to files stored in the memory of said server and that may be accessed by a privileged user of one of said handheld devices or a privileged person or entity not in possession of such a handheld device, but nevertheless having an interest in providing content that may be used by one or more of said handheld devices that are provided the privilege to access and download such content from said server.

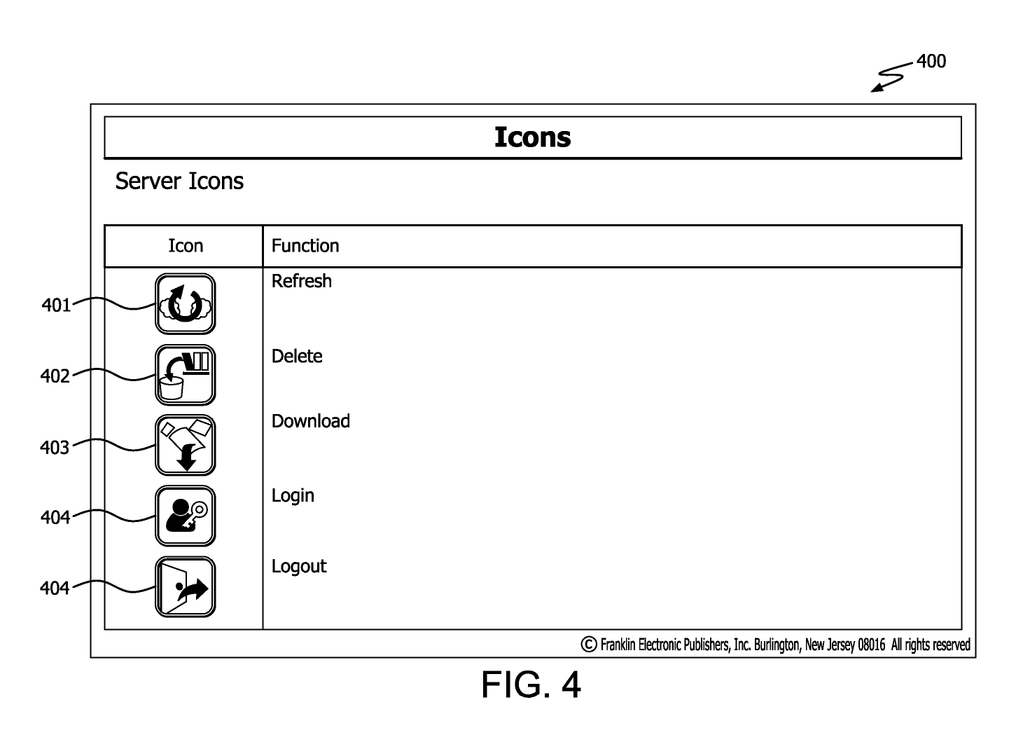

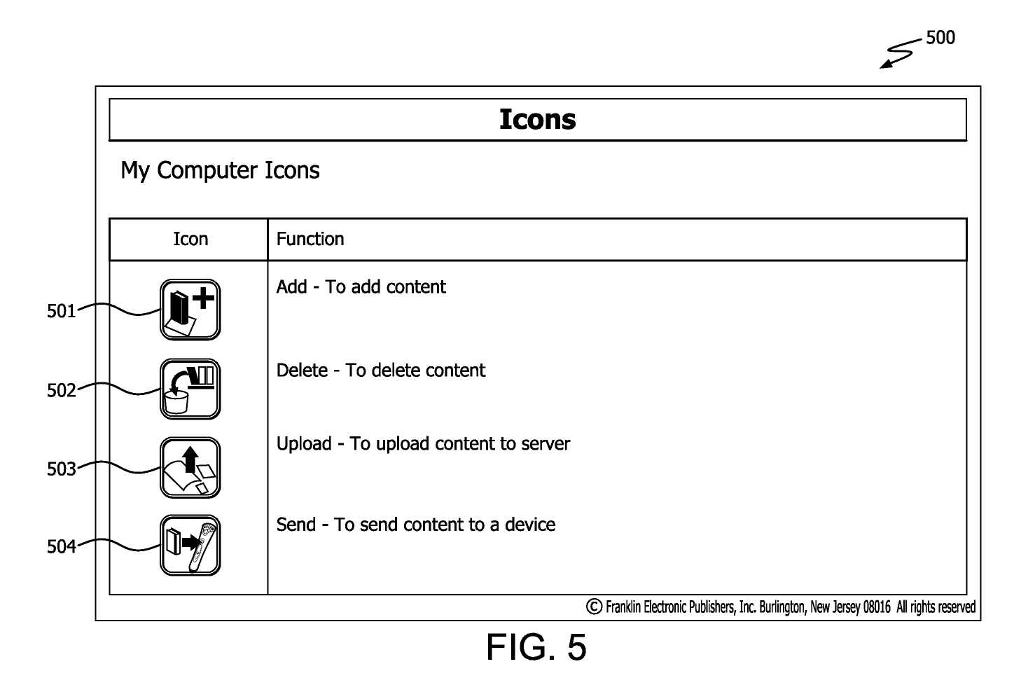

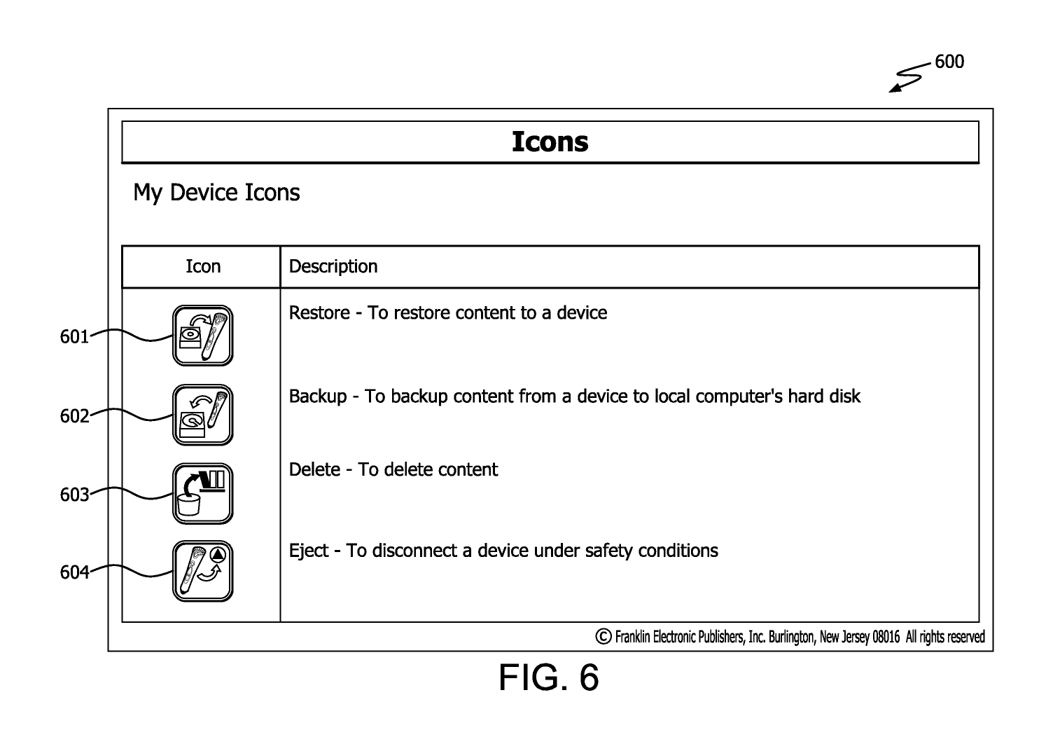

Desktop 10 is comprised, in part, of a row of function icons 100 that allow the desktop user to control operations in each of the three sectors (local computer 70, device 20, and server 73) of the desktop. Icon set 400 (depicted in further detail in FIG. 4 and comprised of icons 401, 402, 403, and two setting icon 404) allows the user to click on (or touch) an icon to control operation in the server sector of the desktop. Icon set 500 (depicted in further detail in FIG. 5 and comprised of icons 501, 502, 503, and 504) allows the user to click on (or touch) an icon to control operation in the local computer sector of the desktop. Icon set 600 (depicted in further detail in FIG. 6 and comprised of icons 601, 602, 603, and 604) allows the user to click on (or touch) an icon to control operation in the device sector of the desktop. Desktop 10 encompasses a three part tab 140 indicating and providing for each of the three sectors—sector 110 for tracking and operating on digital audio files stored in memory of the local computer; sector 120 for tracking and operating on digital audio files stored in memory of a handheld electronic device in the possession of the user; and sector 130 for tracking and operating on digital audio files stored in the server. Local computer sector 110 in this FIG. 1 indicates that three digital audio files representing three print books—Book 1 numbered 111, Book 2 numbered 112, and Book 3 numbered 113 have been stored in memory of the local computer 70—and further indicates for each the size of such content, the number of pages represented therein (which correspond to the number of data carriers necessary therefor), and the last time of editing each of such audio digital files. Additionally, such indications include information as to whether the recordings for such books have been completed as shown (Book being “Complete” while Books 2 and 3 are yet to be completed). Under sector 110, a user may add or edit up to 200 books in the preferred embodiment consisting of up to 200 pages for each such book and up to 26 data carriers correlated to each such book with a maximum time of recording of 15 minutes in connection with the files correlated to each such data carrier. The reader will appreciate that the system may be expanded in order to minimize such limitations. Using such sector 110, the user is provided the ability to upload book cover graphics (in a jpeg file) and the title for each book as a part of, for example, any one of Book 111, Book 112, or Book 113. Each data carrier that will be used in such books is assigned by the application program a unique serial number that serves to correlate the audio file with a unique identifier printed on such data carrier to be read by an electronic aid in which is stored such correlated content. Other functions accessible via tab 140 for sector 110 include electronic “morphing” of the voice stored in a digital audio file and playback of audio files recorded using the program controlling sector 110. Tab 140 indicates with the entry “Books x3” that in sector 110 three books have been stored by the desktop user.

Sector 120 indicates whether a user of the desktop who has possession of a handheld electronic aid, such as that labeled 20 in FIG. 2, has presently connected that device to the local computer. Tab 140 indicates that an electronic aid is connected to the local computer of the user of the desktop in FIG. 1. Sector 120 indicates at its section 121 the number of books downloaded from the memory of local computer 70 and then stored in the device and the memory capacity needed to store each such book. Additionally, section 121 can be programmed to indicate the name of each book (not shown in FIG. 1).

Section 122 of sector 120 indicates by a gauge how much time or memory space is used or available in the electronic aid that is connected to the local computer of the user of the desktop, that is how much replay time or memory space in the device is taken up by books downloaded from the local computer, how much replay time or memory space in the device is taken up by books recorded directly on the device, and how much space or time remains available in the device. Section 123 of sector 120 indicates the sticker numbers of the data carriers that correlate to the identifiers on said data carriers that relate to the audio files recorded directly on and stored in said electronic aid. Tab 140 allows the user to take additional action with respect to the device, such as, entering a name for the device, especially helpful in the case in which the desktop is used to control more than one electronic aid, such as in the case in which a family has two children, each of which has an electronic aid, or in the classroom use situation, in which each of thirty devices may be “named” with the actual first name of each pupil.

Sector 130 of desktop 10 provides the user of said desktop access to audio files stored in server 73 (shown in FIG. 7), to which audio files said user has been provided authorization, whether because said user uploaded such files or is granted permission by others who have uploaded such files to said server 73. For example, FIG. 1 shows four storage areas on the server to which the user of desktop 10 has access. That a storage area of the server has been populated with books uploaded by “Grandmom” is indicated by section 131 of sector 130. As section 131 of FIG. 1 indicates, three books uploaded by her have been downloaded (or “shared”) to a sector 110 by others who have been granted access to that storage area of the server 73. Additional functionality for a user accessing the server is provided in tab 140, such as inviting others to use the book sharing system of the present invention, or to upload graphic files of the cover of books to the server 73.

FIG. 2 is a perspective view of a handheld electronic aid 20 that is known in the art that has been modified for use with the preferred embodiment of the present invention. The aid has been outfitted with USB port 21 to allow the aid to be linked electrically with a local computer 70 (as shown in FIG. 7) via a standard USB cable 22 (not shown in FIG. 2, but indicated in the block diagram of FIG. 7). As may be appreciated, such aid 20 may also be electronically connected to local computer 70 by wireless connection, such as by utilization of the protocol known in the art as Bluetooth™.

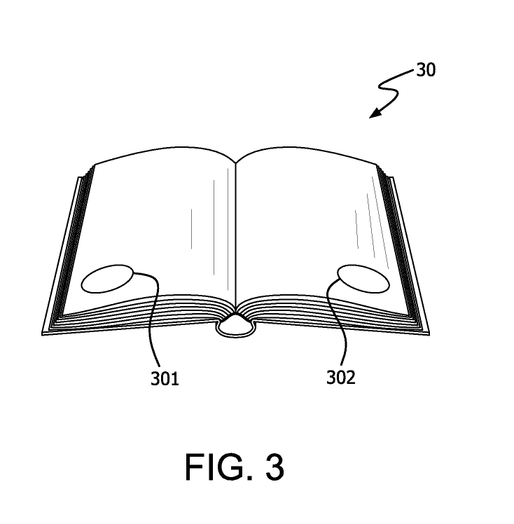

A printed book 30 to be used in connection with the preferred embodiment of the present invention is shown in FIG. 3. Data carrier 301 in the form of a round sticker having identifiers set forth thereon (invisible to the naked eye, and for that reason not show in FIG. 3) has been affixed to the left hand page of book 30 by a removable adhesive as is known in the art. Similar data carrier 302 having a different identifier set forth thereon but as well not shown is similarly affixed to the right hand page of book 30. Each of stickers 301 and 302 in the preferred embodiment of this invention shall have printed serial numbers visible thereon (not shown in FIG. 3).

FIGS. 4, 5, and 6 are screen shots of icons for use by the user of desktop 10 in each of sectors 130, 110, and 120 respectively in order to control the operation of the application program running on local computer 70 vis a vis the server 73, the memory of said local computer 70, and a device, such as device 20, connected via a USB cable to local computer 70.

Turning to FIG. 4, a screenshot of the illustrative icons of part 400 of desktop 10 to be used by clicking through (or touching, in the case of a touch screen computer, such as a tablet or smartphone) by a user of sector 130 on said desktop juxtaposed with a description of the function controlled thereby, one can appreciate the functions that can be employed with respect to the server 73 by the user of said desktop. Differential icons 404, the login and logout icons, may be used by the user of desktop 10 firstly to gain access to the files stored on server 73, that is, by clicking on (or touching) the “login” icon 404. Once access has been so gained, login icon 404 is modified by action of application software program controlling said desktop 109 into “logout” icon 404 as is depicted on FIG. 1 since the desktop shown therein presupposes the user's access to the server and therefore shows “logout” as the operative position of icon 404. As can be appreciated as it is well known in the art, clicking on or touching login icon 404 will thereafter prompt the user to enter a password or other identifying code that will open the operative and allowed sections of sector 130 (in the case of FIG. 1 the sections titled “Grandmom” 131, Sally's Mom, Sally's Dad, and Grandson, access to which the user of desktop 10 is entitled once the proper password has been entered). Clicking on any one of server icons 401, 402, and 403 causes the functions shown in FIG. 4 to be exercised by the underlying application software computer program of local computer 70, specifically and respectively, (i) refreshing the screen display of sector 130 to indicate books then available for download; (ii) deleting books from the server 73 that have been uploaded by the user of desktop 10; or (iii) downloading authorized books from the server 73 to local computer 70 for use by the user of desktop 10.

FIG. 5 is a screenshot of the graphic icons of part 500 of desktop 10 to be used by clicking through (or touching) by a user of sector 110 on that desktop juxtaposed with a description of the function controlled thereby to be employed with respect to the memory of local computer 70 by the user of said desktop. Icon 501 may be left clicked by the user of desktop 10 add content to the memory of the local computer 70, that is, by recording audio files (via hardware and compatible application software built into local computer 70) and correlating those files to data carriers identified by unique “sticker number” with the result that the sticker number sequence for use with a book can be determined in the full discretion of the user of desktop 10 notwithstanding whether the audio files were downloaded from the server, recorded on the local computer, or uploaded from a device. In this way, the stickers (data carriers) to be affixed to a print book can be correlated precisely to identifiers set forth on each of them and to the proper content recorded by the user of desktop 10 and stored in memory of local computer 70. The user of sector 110 of desktop 10 can assign serial numbered stickers to audio files simply by entering the serial numbers into sector 110. As a convenience, consecutive serial numbers can be automatically entered by the application program once the first serial number is typed in by the user. Icon 502 allows the user to delete content stored as a book in local computer 70 memory. Icon 503 is used by the user of desktop 10 to upload content recorded and stored in local computer to server 73 memory and identified in sector 130 of desktop 10 as a book available for download from by others authorized to download content uploaded by that user to the server. Icon 504 allows for the user of desktop 10 to send content recorded on the local computer 70 to that user's device that is connected to the local computer as shown by tab 140 as it relates to sector 120 of desktop 10.

The icons of part 600 of desktop 10 are shown in screenshot of FIG. 6, which icons are intended to be clicked through or touched by a user of sector 120 of desktop 10, in each case with a description of the function controlled thereby. Icon 601 can be clicked or touched by the user to restore content that was stored in the handheld device connected to local computer 70 that had been backed up by storing such content in the hard drive of local computer 70 (whether stored in such memory by downloading from server 73, by recording using local computer 70, or by being backed up after having been recorded directly on handheld electronic aid 20). Backing up content is accomplished by the user by the use of icon 602, which allows the user to transfer specific audio files that were recorded on the handheld electronic aid directly or downloaded from the memory of the local computer 10 into the memory of said handheld device back into the memory of local computer 70. Icon 603 is used by the user of desktop 10 and the possessor of electronic aid 20 to delete audio files that are then presently stored in the memory of said electronic aid. Icon 604 is clicked in the case that the user of desktop 10 desires to disconnect the USB connection between local computer 70 and handheld electronic aid 20 without losing any content stored either in such local computer memory or the memory of said handheld device.

FIG. 7 is a block diagram of the system of the preferred embodiment of the present invention showing the connection of handheld electronic aid 20 (by way of USB cable 22) to local computer 70 (on which runs the application program that controls desktop 10) which is connected to the world wide web 72 by browser technology as is well known in the art. Another local computer 71 is shown without connection to an electronic aid, used herein to simulate the local computer used by Grandmom back East to record a book for her grandson and upload it to server 73 from her local computer 71.

The operation of the system of the preferred embodiment for the linking of data carriers via a network is intended to be seamless for users having access to a local computer only, or a local computer in combination with a handheld electronic aid as described hereinbefore so as to allow the user without a handheld device to record information in the form of digital audio files on a local computer that can be properly correlated with indentifiers on data carriers in the proper sequence that are affixed to pages of a print book in that sequence without the need for the recordings to be made in direct conjunction with data carriers, as is done with an electronic device in the presence of the affixed data carriers as is known in the art. The operation of the system is best appreciated in juxtaposition, as a diptych, that is, first from the view of the prior art, that is, by description of the recording of audio files and correlation of stickers by one having only a handheld device, data carriers, and a print book as juxtaposed with the inventive steps of recording and correlating from afar, via a network.

The procedure necessitated by the use of the electronic aid alone to make recordings is as follows: first, the user identifies a book 30 to be read aloud to a child. To the pages of the book 30 are affixed data carriers 31 and 32 on which are identifiers, not visible to the naked eye, unique to each data carrier, which identifiers are readable by an electronic aid 20 in accordance with known technology. The user switches the electronic aid into its record mode and uses the tip of the electronic aid to scan the data carrier 301 on the first page of the book 30 which correlates the identifiers thereon with the memory location into which a digital audio file about to be recorded is to be stored. The user then records, using his or her own voice, the words on the first page of book 30. When the child for whom the recording is made scans the sticker 301 on said first page of book 30 using the electronic aid in the play mode, he or she hears the audio file played out loud, that is, a reading of the words on the page in the voice of the person who made the recording.

The improvement to the procedure spelt out above is as follows: In addition to recording audio files directly on an electronic aid after scanning the identifiers on data carriers given to the spatial proximity of the act of making the recording and the placing of tangible data carriers with identifiers thereon so correlated to such audio files, using the instant invention a geographically disparate person without the aid of an electronic aid and without physical access to data carriers can record audio files of specific pages of a book using his or her own voice so that those files can be heard out loud miles away by a user with an electronic aid and a book with unique data carriers affixed thereon so that the files are properly correlated to the pages of the book. In this context, uniqueness means that the device user chooses the serial numbered data carriers to be used on each page in his full discretion. Using this improvement, a user of a local computer 71 as shown in FIG. 7, without access to a handheld electronic aid, but with the application software program that controls desktop 10 loaded therein, can use sector 110 of the desktop 10 running thereon to record each page, page by page, of book 20 by use of icon 501 to add such content into memory of her local computer 71. Such content is, under the control of the application software program, available to be correlated to sticker numbers as if the recording was made on an electronic aid. The files can then be uploaded by the user of local computer 71 to the server 73 by clicking on icon 503. That user can then, using the functions of tab 140, notify the intended recipient of that recording that the files are ready for download from server 73. The intended recipient, using his or her local computer 70, can thereafter click on icon 404 on his desktop 10 to gain access to server 73, and, once having provided the proper password when prompted, can click on or touch icon 403 to download such correlated files into the memory of his local computer 70. Information about the downloaded files then appears in sector 110 of desktop 10, such as for the content of Book 1 as in subsection 111 as shown in FIG. 1. Subsection 111 is then used to assign the serial numbers of data carriers in the possession of the user of local computer 70 to each of the separate recorded audio files in the downloaded book. A series of consecutive serial numbers can be entered merely by entering the first serial number, under the control of the application software program. Once stored therein, the intended recipient of the far away recorded, yet now properly correlated, audio files can connect his or her electronic aid 20 via USB cable 22 to local computer 70, and thereafter click on icon 504 to send that correlated content to the memory of electronic aid 20. The data carriers in the possession of such user are placed properly on the pages of book 30 from the same starting page and in the same sequence as identified in subsection 111. The child then uses the electronic aid to scan the data carriers properly sequenced on the pages of book 30 to hear out loud the recordings made by grandmother across a continent.

Additionally, the user of device 20 can utilize sector 110 of his own desktop 10 to record audio files and assign serial numbers to such files, without recording on the device with said data carriers in close proximity.

As can be appreciated, the procedure spelt out above is also applicable to the situation in which a publisher of children's books uploads an audible version of its book for download by thousands of users of electronic aids or the situation in which a teacher uploads for all the thirty students in her class audible notes, reminders, mnemonics, or hints to be read out loud while study is in progress in correlation with stickers placed on pages of the textbook that is being used by all thirty of those students.

What is claimed is:

1. A method for sharing information in the form of digital audio files among a plurality of users in order to facilitate the reading aloud of words entered on the pages of printed books using at least one handheld electronic aid, a plurality of personal computers, tablet computers, or smartphones, at least one server, and a network by which such computers or smartphones and server are connected, comprising the steps of:
recording, by a first user, of a plurality of sequenced audio files corresponding to the words printed on consecutive pages of a printed book and correlated with the sequence of such pages into the memory of a personal computer, tablet computer, or smartphone;
uploading, by such first user, of such sequenced audio files from such memory via said network into the memory of such server;
granting access, by such first user, to a plurality of second users, to such files as stored in said memory of such server;
downloading, by one or more of such second users, of such audio files into memory of a plurality of personal computers, tablet computers, or smartphones of such second users;
transferring, by one or more of such second users, of such audio files from such memory of such personal computers, tablet computers, or smartphones, via a connection into memory of one or more of handheld electronic aids of such second users;
affixing, by a plurality of such second users, of a plurality of sequenced and correlated self-sticking data carriers, having serial numbers printed thereon and identifiers readable by such electronic aids set forth thereon, onto said consecutive pages of said plurality of said printed books; and
scanning said data carriers by said second users with said electronic aids of said second users whereby said consecutive pages of said printed book are read out aloud as the audio files stored in memory of said electronic aid are played in proper sequence with the sequential scanning of each of said data carriers by which the identifiers set forth thereon cause the properly correlated audio files to be played out loud by such electronic aid.

2. The method of claim 1 in which said connection is tangible, such as a USB cable.

3. The method of claim 1 in which said connection is wireless, such as a bluetooth connection.

4. The method of claim 1 in which said personal computer, tablet computer, or smartphone has an application software program running therein that controls a desktop on such personal computer, tablet computer, or smartphone.

5. The method of claim 4 in which said connection is, tangible, such as a USB cable.

6. The method of claim 4 in which said connection is wireless, such as a bluetooth connection.

7. The method of claim 1 in which said uploading is accomplished through the operation of a browser on the internet.

8. The method of claim 7 in which said connection is, tangible, such as a USB cable.

9. The method of claim 7 in which said connection is wireless, such as a bluetooth connection.

10. The method of claim 1 in which said downloading is accomplished through the operation of a browser on the internet.

11. The method of claim 10 in which said connection is, tangible, such as a USB cable.

12. The method of claim 10 in which said connection is wireless, such as a bluetooth connection.

13. The method of claim 1 in which said uploading is accomplished by clicking on an icon on a desktop of a personal computer.

14. The method of claim 13 in which said connection is, tangible, such as a USB cable.

15. The method of claim 13 in which said connection is wireless, such as a bluetooth connection.

16. The method of claim 1 in which said downloading is accomplished by clicking on an icon on said desktop of a personal computer.

17. The method of claim 16 in which said connection is, tangible, such as a USB cable.

18. The method of claim 16 in which said connection is wireless, such as a bluetooth connection.

19. The method of claim 1 in which said transferring is accomplished by clicking on an icon on said desktop of a personal computer.

20. The method of claim 19 in which said connection is, tangible, such as a USB cable.

21. The method of claim 19 in which said connection is wireless, such as a bluetooth connection.

22. The method of claim 1 in which said uploading is accomplished by touching an icon on said desktop of a tablet computer or smartphone.

23. The method of claim 22 in which said connection is, tangible, such as a USB cable.

24. The method of claim 22 in which said connection is wireless, such as a bluetooth connection.

25. The method of claim 1 in which said downloading is accomplished by touching an icon on said desktop of a tablet computer or smartphone.

26. The method of claim 25 in which said connection is, tangible, such as a USB cable.

27. The method of claim 25 in which said connection is wireless, such as a bluetooth connection.

28. The method of claim 1 in which said transferring is accomplished by touching an icon on said desktop of a tablet computer or smartphone.

29. The method of claim 28 in which said connection is, tangible, such as a USB cable.

30. The method of claim 28 in which said connection is wireless, such as a bluetooth connection.

31. An improved method for recording information to facilitate the reading aloud of words entered on the pages of printed books using a handheld electronic aid that is outfitted to scan data carriers affixed to consecutive pages of such book, which data carriers have identifiers set forth thereon, which scanning causes correlated audio file stored in said electronic aid to be played out loud by such electronic aid, which improvement comprises the steps of:
connecting such a handheld electronic aid to a personal computer, tablet computer, or smartphone;
recording a plurality of sequenced audio files corresponding to the words printed on consecutive pages of such a printed book into the memory of a personal computer, tablet computer, or smartphone;
transferring such audio files from such memory of such personal computer, tablet computer, or smartphone, via such electrical connection into memory of said handheld electronic aid;
affixing a plurality of sequenced self-sticking data carriers, having serial numbers printed thereon and identifiers readable by such electronic aids set forth thereon, onto said consecutive pages of said printed book; and
scanning said data carriers with said electronic aid whereby said consecutive pages of said printed book are read aloud as the audio files stored in memory of said electronic aid are played in correlation with the scanning of each data carrier by which the identifiers set forth thereon cause the correlated audio files to be played by such electronic aid.

32. The improved method of claim 31 in which said connection is, tangible, such as a USB cable.

33. The improved method of claim 31 in which said connection is wireless, such as a bluetooth connection.

34. The improved method of claim 31 in which said personal computer, tablet computer, or smartphone has an application software program running therein that controls a desktop on such personal computer, tablet computer, or smartphone.

35. The improved method of claim 34 in which said connection is, tangible, such as a USB cable.

36. The improved method of claim 34 in which said connection is wireless, such as a bluetooth connection.

37. The improved method of claim 31 in which said transferring is accomplished by clicking on an icon on said desktop of a personal computer.

38. The improved method of claim 31 in which said connection is, tangible, such as a USB cable.

39. The improved method of claim 31 in which said connection is wireless, such as a bluetooth connection.

40. The improved method of claim 31 in which said transferring is accomplished by touching an icon on said desktop of a tablet computer or smartphone.

41. The improved method of claim 40 in which said connection is, tangible, such as a USB cable.

42. The improved method of claim 40 in which said connection is wireless, such as a bluetooth connection.

43. A system for sharing information in the form of digital audio files among a plurality of users in order to facilitate the reading aloud of words entered on the pages of printed books consisting of at least one handheld electronic aid, a plurality of personal computers, tablet computers, or smartphones, a connection between at least one such electronic aid and at least one of such personal computers, tablet computers, or smartphones, at least one server, and a network by which such computers or smartphones and server are connected, whereby a recording of a plurality of sequenced audio files corresponding to the words printed on consecutive pages of a printed book is correlated with the sequence of such pages into the memory of a personal computer, tablet computer, or smartphone and by which such sequenced audio files are uploaded from such memory via said network into the memory of such server to which access has been granted to a plurality of users who, using such access download such audio files into memory of one or more personal computers, tablet computers, or smartphones to allow the transferring of such audio files from such memory of such personal computers, tablet computers, or smartphones, via a connection into memory of one or more of handheld electronic aids and the affixing, of a plurality of sequenced and correlated self-sticking data carriers, having serial numbers printed thereon and identifiers readable by such electronic aids set forth thereon, onto said consecutive pages of said printed books for scanning of said data carriers with said electronic aids whereby said consecutive pages of said printed book are read out aloud as the audio files stored in memory of said electronic aid are played in proper sequence with the sequential scanning of each of said data carriers by which the identifiers set forth thereon cause the properly correlated audio files to be played out loud by such electronic aid.

44. The system of claim 43 in which said connection is a tangible connection, such as a USB cable.

45. The system of claim 43 in which said connection is a wireless connection, such as a bluetooth connection.

46. The system of claim 43 in which said personal computer, tablet computer, or smartphone has an application software program running therein that controls a desktop on such personal computer, tablet computer, or smartphone.

47. The system of claim 46 in which said connection is a tangible connection, such as a USB cable.

48. The system of claim 46 in which said connection is a wireless connection, such as a bluetooth connection.

49. The system of claim 43 in which said uploading is accomplished through the operation of a browser on the internet.

50. The system of claim 49 in which said connection is a tangible connection, such as a USB cable.

51. The system of claim 49 in which said connection is a wireless connection, such as a bluetooth connection.

52. The system of claim 43 in which said downloading is accomplished through the operation of a browser on the internet.

53. The system of claim 52 in which said connection is a tangible connection, such as a USB cable.

54. The system of claim 52 in which said connection is a wireless connection, such as a bluetooth connection.

55. The system of claim 43 in which said uploading is accomplished by clicking on an icon on a desktop of a personal computer.

56. The system of claim 55 in which said connection is a tangible connection, such as a USB cable.

57. The system of claim 55 in which said connection is a wireless connection, such as a bluetooth connection.

58. The system of claim 43 in which said downloading is accomplished by clicking on an icon on said desktop of a personal computer.

59. The system of claim 58 in which said connection is a tangible connection, such as a USB cable.

60. The system of claim 58 in which said connection is a wireless connection, such as a bluetooth connection.

61. The system of claim 43 in which said transferring is accomplished by clicking on an icon on said desktop of a personal computer.

62. The system of claim 61 in which said connection is a tangible connection, such as a USB cable.

63. The system of claim 61 in which said connection is a wireless connection, such as a bluetooth connection.

64. The system of claim 43 in which said uploading is accomplished by touching an icon on said desktop of a tablet computer or smartphone.

65. The system of claim 64 in which said connection is a tangible connection, such as a USB cable.

66. The system of claim 64 in which said connection is a wireless connection, such as a bluetooth connection.

67. The system of claim 43 in which said downloading is accomplished by touching an icon on said desktop of a tablet computer or smartphone.

68. The system of claim 67 in which said connection is a tangible connection, such as a USB cable.

69. The system of claim 67 in which said connection is a wireless connection, such as a bluetooth connection.

70. The system of claim 43 in which said transferring is accomplished by touching an icon on said desktop of a tablet computer or smartphone.

71. The system of claim 70 in which said connection is a tangible connection, such as a USB cable.

72. The system of claim 70 in which said connection is a wireless connection, such as a bluetooth connection.

73. In an electronic system for reading aloud the words entered on pages of a printed book consisting of data carriers for use with a handheld electronic aid adapted for reading aloud information stored in such electronic aid that is correlated to identifiers printed on such data carriers, the combination with said electronic aid and data carriers of a plurality of personal computers, tablet computers, or smartphones, a connection between at least one such electronic aid and at least one of such personal computers, tablet computers, or smartphones, visible serial numbers printed or otherwise affixed to such data carriers, at least one server, and a network by which such computers or smartphones and server are connected, whereby a plurality of sequenced audio files corresponding to the words printed on consecutive pages of a printed book correlated with the sequence of such pages may be recorded and stored into the memory of a personal computer, tablet computer, or smartphone, with the result that such sequenced audio files may be uploaded from such memory via said network into the memory of such server to which access may be granted to a plurality of users who, using such access, download such audio files into memory of one or more personal computers, tablet computers, or smartphones by which such files may be transferred from such memory of such personal computers, tablet computers, or smartphones, via such connection into memory of one or more of handheld electronic aids and a plurality of sequenced and correlated self-sticking data carriers, having serial numbers printed thereon and identifiers readable by such electronic aids set forth thereon, may be affixed onto said consecutive pages of said printed books for scanning of said data carriers with said electronic aid whereby said consecutive pages of said printed book are read out aloud as the audio files stored in memory of said electronic aid are played in proper sequence with the sequential scanning of each of said data carriers by which the identifiers set forth thereon cause the properly correlated audio files to be played out loud by such electronic aid.

74. The combined system of claim 73 in which said connection is a tangible connection, such as a USB cable.

75. The combined system of claim 73 in which said connection is a wireless connection, such as a bluetooth connection.

76. The combined system of claim 73 in which said personal computer, tablet computer, or smartphone has an application software program running therein that controls a desktop on such personal computer, tablet computer, or smartphone.

77. The combined system of claim 76 in which said connection is a tangible connection, such as a USB cable.

78. The combined system of claim 76 in which said connection is a wireless connection, such as a bluetooth connection.

79. The combined system of claim 73 in which said uploading is accomplished through the operation of a browser on the internet.

80. The combined system of claim 79 in which said connection is a tangible connection, such as a USB cable.

81. The combined system of claim 79 in which said connection is a wireless connection, such as a bluetooth connection.

82. The combined system of claim 73 in which said downloading is accomplished through the operation of a browser on the internet.

83. The combined system of claim 82 in which said connection is a tangible connection, such as a USB cable.

84. The combined system of claim 82 in which said connection is a wireless connection, such as a bluetooth connection.

85. The combined system of claim 73 in which said uploading is accomplished by clicking on an icon on a desktop of a personal computer.

86. The combined system of claim 85 in which said connection is a tangible connection, such as a USB cable.

87. The combined system of claim 85 in which said connection is a wireless connection, such as a bluetooth connection.

88. The combined system of claim 73 in which said downloading is accomplished by clicking on an icon on said desktop of a personal computer.

89. The combined system of claim 88 in which said connection is a tangible connection, such as a USB cable.

90. The combined system of claim 88 in which said connection is a wireless connection, such as a bluetooth connection.

91. The combined system of claim 73 in which said transferring is accomplished by clicking on an icon on said desktop of a personal computer.

92. The combined system of claim 91 in which said connection is a tangible connection, such as a USB cable.

93. The combined system of claim 91 in which said connection is a wireless connection, such as a bluetooth connection.

94. The combined system of claim 73 in which said uploading is accomplished by touching an icon on said desktop of a tablet computer or smartphone.

95. The combined system of claim 94 in which said connection is a tangible connection, such as a USB cable.

96. The combined system of claim 94 in which said connection is a wireless connection, such as a bluetooth connection.

97. The combined system of claim 73 in which said downloading is accomplished by touching an icon on said desktop of a tablet computer or smartphone.

98. The combined system of claim 97 in which said connection is a tangible connection, such as a USB cable.

99. The combined system of claim 97 in which said connection is a wireless connection, such as a bluetooth connection.

100. The combined system of claim 73 in which said transferring is accomplished by touching an icon on said desktop of a tablet computer or smartphone.

101. The combined system of claim 100 in which said connection is a tangible connection, such as a USB cable.

102. The combined system of claim 100 in which said connection is a wireless connection, such as a bluetooth connection.

103. An improved electronic system for reading aloud the words entered on pages of a printed book of the type having a handheld electronic aid that is outfitted to scan data carriers affixed to consecutive pages of such book, which data carriers have identifiers set forth thereon, which scanning causes correlated audio file stored in said electronic aid to be played out loud by such electronic aid wherein the improvement comprises a personal computer, tablet computer, or smartphone, a connection between said electronic aid and such computer or smartphone, the affixing of serial numbers to such data carriers, a server, and a network by which such computer or smartphone and server are connected, whereby a recording of a plurality of sequenced audio files corresponding to the words printed on consecutive pages of a printed book is correlated with the sequence of such pages into the memory of such personal computer, tablet computer, or smartphone and by which such are transferred from such memory of such computers or smartphone via an electrical connection into memory of such handheld electronic aid and such plurality of sequenced and correlated self-sticking data carriers, having serial numbers printed thereon and identifiers readable by such electronic aids set forth thereon, are affixed onto said consecutive pages of said printed books for scanning of said data carriers with said electronic aid whereby said consecutive pages of said printed book are read out aloud as the audio files stored in memory of said electronic aid are played in proper sequence with the sequential scanning of each of said data carriers by which the identifiers set forth thereon cause the properly correlated audio files to be played out loud by such electronic aid.

104. The improved electronic system of claim 103 in which said connection is a tangible connection, such as a USB cable.

105. The improved electronic system of claim 103 in which said connection is a wireless connection, such as a bluetooth connection.

106. The improved electronic system of claim 103 in which said personal computer, tablet computer, or smartphone has an application software program running therein that controls a desktop on such personal computer, tablet computer, or smartphone.

107. The improved electronic system of claim 106 in which said connection is a tangible connection, such as a USB cable.

108. The improved electronic system of claim 106 in which said connection is a wireless connection, such as a bluetooth connection.

109. The improved electronic system of claim 103 in which said transferring is accomplished by clicking on an icon on said desktop of a personal computer.

110. The improved electronic system of claim 109 in which said connection is a tangible connection, such as a USB cable.

111. The improved electronic system of claim 109 in which said connection is a wireless connection, such as a bluetooth connection.

112. The improved electronic system of claim 103 in which said transferring is accomplished by touching an icon on said desktop of a tablet computer or smartphone.

113. The improved electronic system of claim 112 in which said connection is a tangible connection, such as a USB cable.

114. The improved electronic system of claim 112 in which said connection is a wireless connection, such as a bluetooth connection.

115. The improved electronic system of claim 103 further comprising a plurality of personal computers, tablet computers, or smartphones, at least one server, and a network by which such computers or smartphones and server are connected, whereby a recording of a plurality of sequenced audio files corresponding to the words printed on consecutive pages of a printed book may be correlated with the sequence of such pages and stored directly into the memory of a personal computer, tablet computer, or smartphone and by which such sequenced audio files may thereafter be uploaded from such memory via said network into the memory of such server to which access has been granted to a plurality of users who, using such access may thereafter download such audio files into memory of one or more personal computers, tablet computers, or smartphones to allow the transferring of such audio files from such memory of such personal computers, tablet computers, or smartphones, via said connection into memory of one or more of handheld electronic aids and thereafter a plurality of sequenced and correlated self-sticking data carriers, having serial numbers printed thereon and identifiers readable by such electronic aids set forth thereon, may be affixed onto said consecutive pages of said printed books for scanning of said data carriers with said electronic aids whereby said consecutive pages of said printed book are read out aloud as the audio files stored in memory of said electronic aid are played in proper sequence with the sequential scanning of each of said data carriers by which the identifiers set forth thereon cause the properly correlated audio files to be played out loud by such electronic aid.

116. The improved electronic system of claim 115 in which said connection is a tangible connection, such as a USB cable.

117. The improved electronic system of claim 115 in which said connection is a wireless connection, such as a bluetooth connection.

118. The improved electronic system of claim 115 in which said personal computers, tablet computers, or smartphones have an application software program running therein that controls a desktop on such personal computers, tablet computers, or smartphones.

119. The improved electronic system of claim 118 in which said connection is a USB cable.

120. The improved electronic system of claim 118 wherein such connections are wireless in nature.

121. The improved electronic system of claim 120 wherein such wireless connections are bluetooth connections.

122. The improved electronic system of claim 115 in which said uploading is accomplished through the operation of a browser on the internet.

123. The improved electronic system of claim 122 in which said connection is a USB cable.

124. The improved electronic system of claim 122 wherein such connections are wireless in nature.

125. The improved electronic system of claim 124 wherein such wireless connections are bluetooth connections.

126. The improved electronic system of claim 115 in which said downloading is accomplished through the operation of a browser on the internet.

127. The improved electronic system of claim 126 in which said connection is a USB cable.

128. The improved electronic system of claim 126 wherein such connections are wireless in nature.

129. The improved electronic system of claim 128 wherein such wireless connections are bluetooth connections.

130. The improved electronic system of claim 115 in which said uploading is accomplished by clicking on an icon on a desktop of a personal computer.

131. The improved electronic system of claim 130 in which said connection is a USB cable.

132. The improved electronic system of claim 130 wherein such connections are wireless in nature.

133. The improved electronic system of claim 132 wherein such wireless connections are bluetooth connections.

134. The improved electronic system of claim 115 in which said downloading is accomplished by clicking on an icon on said desktop of a personal computer.

135. The improved electrical system of claim 134 in which said connection is a USB cable.

136. The improved electronic system of claim 134 wherein such connections are wireless in nature.

137. The improved electronic system of claim 136 wherein such wireless connections are bluetooth connections.

138. The improved electronic system of claim 115 in which said transferring is accomplished by clicking on an icon on said desktop of a personal computer.

139. The improved electronic system of claim 138 in which said connection is a USB cable.

140. The improved electronic system of claim 138 wherein such connections are wireless in nature.

141. The improved electronic system of claim 140 wherein such wireless connections are bluetooth connections.

142. The improved electronic system of claim 115 in which said uploading is accomplished by touching an icon on said desktop of a tablet computer or smartphone.

143. The improved electronic system of claim 142 in which said connection is a USB cable.

144. The improved electronic system of claim 142 wherein such connections are wireless in nature.

145. The improved electronic system of claim 144 wherein such wireless connections are bluetooth connections.

146. The improved electronic system of claim 115 in which said downloading is accomplished by touching an icon on said desktop of a tablet computer or smartphone.

147. The improved electrical system of claim 146 in which said connection is a USB cable.

148. The improved electronic system of claim 146 wherein such connections are wireless in nature.

149. The improved electronic system of claim 148 wherein such wireless connections are bluetooth connections.

150. The improved electronic system of claim 115 in which said transferring is accomplished by touching an icon on said desktop of a tablet computer or smartphone.

151. The improved electronic system of claim 150 in which said connection is a USB cable.

152. The improved electronic system of claim 150 wherein such connections are wireless in nature.

153. The improved electronic system of claim 152 wherein such wireless connections are bluetooth connections.
